(19) United States
(12) Patent Application Publication
(10) Pub. No.: US 2025/0077270 A1
(43) Pub. Date: Mar. 6, 2025

(54) CORE ALLOCATION FOR TEMPERATURE CONTROL IN UNDER-SUBSCRIBED COMPUTING SYSTEMS

(71) Applicant: Arm Limited, Cambridge (GB)

(72) Inventors: Allaukik Abhishek, Bee Cave, TX (US); Matthew Douglas Dirba, Austin, TX (US)

(21) Appl. No.: 18/240,405

(22) Filed: Aug. 31, 2023

(51) Int. Cl. G06F 9/38

(52) U.S. Cl. CPC G06F 9/485; G06F 9/5088; G06F 9/5094; G06F 2209/5019; G06F 2209/504

(57) ABSTRACT

A method of core allocation for temperature control in under-subscribed computing systems can include maintaining, by an allocator component, a virtual to physical core mapping of physical cores of a computing system; identifying a change to a next core allocation according to an allocation pattern; determining a time that a process of a software application can be moved to the next core allocation, wherein the process of the software application is configured with core pinning; and updating, by the allocator component, the virtual to physical core mapping for the process of the software application at the determined time. The allocator component can intercept a process request of the software application; identify a pinned core of the process request; and overwrite the pinned core of the process request with an allocated core indicated by the virtual to physical core mapping.

### BACKGROUND

Multicore processors and multicore systems-on-a-chip (SOC) architectures are popular approaches for computing systems used in a variety of application domains. For a server computing system formed of multiple processors and/or cores, the computing cores may not be customized to the particular application. That is, workloads of some of the cores may be undersubscribed such that only a part of the cores are utilized while the rest remain idle. To support the lifespan of a computing system, techniques are often applied by the operating system to allocate operations across the cores of the computing system. For example, a Linux kernel scheduler may be used to allocate operations for uniform wear.

Typically, for determinism and control, software applications use core pinning to indicate which of the cores that they would be using. Software-based core pinning allows the workloads to be distributed across the indicated cores without overlaps, which can also improve performance. Core pinning leads to some cores in the computing system being always active while the others are under-utilized or idle, especially when core scheduling functionality is disabled. This further leads to localized hot zones on the computing system for core clusters, thus degrading the thermal performance of cores in local zones. Similar degradation will result in near-memory read-write behavior, resulting in reduced lifetime of the computing system.

### BRIEF SUMMARY

Core allocation for temperature control in under-subscribed computing systems are described. The temperature control provides wear leveling of the cores for system reliability. An allocator component is presented that manages timing for when software processes are permitted to change cores and can provide an allocation pattern for usage of cores of the computing system. In some cases, the allocator component intercepts process requests to the operating system from the software applications to override a specified core indicated by the software application.

A method of core allocation for temperature control in under-subscribed computing systems can include maintaining a virtual to physical core mapping of physical cores of a computing system: identifying a change to a next core allocation according to an allocation pattern: determining a time that a process of a software application can be moved to the next core allocation, wherein the process of the software application is configured with core pinning; and updating the virtual to physical core mapping for the process of the software application at the determined time.

A method of controlling pinned core affinity for core allocation for temperature control in under-subscribed computing systems can include intercepting a process request of the software application: identifying a pinned core of the process request; and overwriting the pinned core of the process request with an allocated core indicated by the virtual to physical core mapping.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates is a conceptual view of a computing system with a pinned processor affinitizer, providing core allocation for temperature control.

FIG. 2 illustrates a method of core allocation for temperature control in under-subscribed computing systems.

FIG. 3 illustrates a method of controlling pinned core affinity for core allocation for temperature control in under-subscribed computing systems.

FIG. 4 illustrates operation of a computing system with a pinned processor affinitizer, providing core allocation for temperature control.

### DETAILED DESCRIPTION

Core allocation for temperature control in under-subscribed computing systems are described. The temperature control provides wear leveling of the cores for system reliability. An allocator component is presented that manages timing for when software processes are permitted to change cores and can provide an allocation pattern for usage of cores of the computing system. In some cases, the allocator component intercepts process requests to the operating system from the software applications to override a specified core indicated by the software application. The described methods can, during run-time, perform pinned processor affinitizing, supporting randomized core allocation even when the software application is configured for core pinning and the core scheduling functionality of the operating system is disabled. Advantageously, it is possible to alleviate or reduce the hot spot creation issue caused by core pinning.

As an illustrative example, there may be 24, 32, or even 80 or more cores in a server SOC, depending on processor architecture. If a particular application needs only 10 cores out of 80 cores in the SOC, the application may pin cores 0-9 for its functionality. In the traditional method, the cores 0-9 will be heavily utilized while 10-79 are unused. This would lead to localized degradation of thermal, memory, physical interconnect, etc. The described methods can, during run-time, perform pinned processor affinitizing to other cores. For example, for some time, the cores 0-9 are used: then, the functionality switches to cores 10-19 and so on. Thus, the cores are uniformly aged, resulting in better error performance of the SOC in the long run.

Because a purpose of core pinning is to improve performance of an application (e.g., speed performance), including the ability to use a core's cache more effectively, any changes to the expected operation of an application must therefore take into consideration the user's intention. This is especially important when the user's intention is to optimize for performance (e.g., by using Linux tools for controlling operations including for pinning to certain cores/CPUs and for disabling power saving modes). Indeed, a critical issue for certain applications is the potential for a cache miss or a missed execution. Accordingly, the described methods for core allocation involves determining not just whether to change cores for wear purposes but also when to change cores.

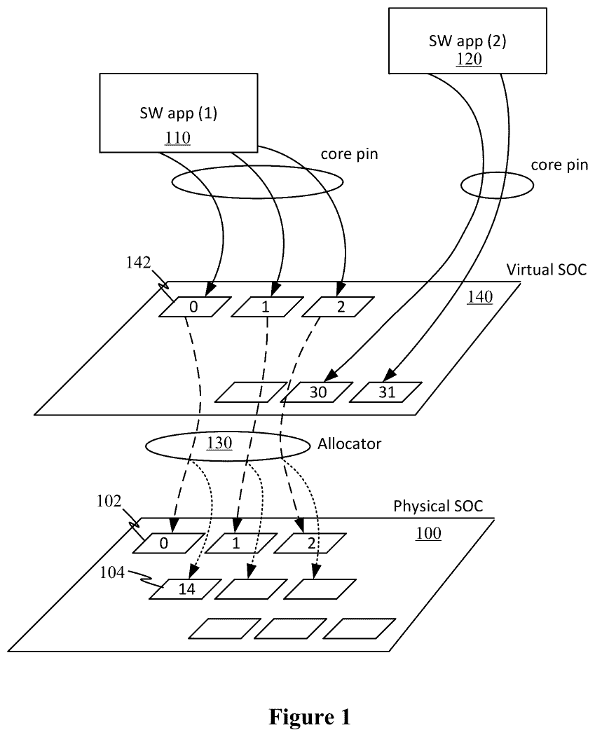

FIG. 1 is a representational diagram of a computing system with application agnostic core randomization. Referring to FIG. 1, a computing system such as a physical SOC 100 can include a number of cores, or “processing units”, on the chip. Software such as first software application 110 and second software application 120 can apply core pinning, for example, with first software application 110 indicated that cores 0-2 are pinned and second software application 120 indicating that cores 30 and 31 are pinned. The core pinning allows the software applications to indicate which of the cores that they would be using for a process request. A process request of a software application is a request by a software application to an operating system for a processor to perform one or more instructions.

An allocator 130 is provided that intercepts the core allocation from the software applications and controls actual core allocation on the physical SOC 100, which results in a virtual SOC 140 for the software applications. That is, as part of the allocator 130, a virtual to physical core mapping is created that produces a virtual computing system (e.g., SOC 140) for software applications (e.g., first software application 110, second software application 120) so that the underlying physical system (e.g., SOC 100) can be utilized in a manner that alleviates the hot spot creation issue. Indeed, as mentioned above, localized hot zones, or hotspots, are generated when a particular core is operating/performing workloads. Localized heating starts happening at and around the core, which degrades the material and physics around it. In this manner, a main driver of wear is temperature. Therefore, by reducing the temperature hotspot and moving the temperature hotspot around the grid is going to be a factor that improves aging.

A software application can indicate a specified core affinity due to being configured with core pinning and the virtual to physical core mapping can indicate the particular physical core associated with that specified core affinity. The virtual to physical core mapping can be periodically and dynamically changed at logical conducive or prescribed times. This will lead to using the cores more uniformly in the SOC lifecycle while minimizing adverse effects of changing cores. In addition, the allocator 130 can operate to overwrite the pinned core of the process request with an allocated core indicated by the virtual to physical core mapping such that the application is unaware that the pinned cores have moved.

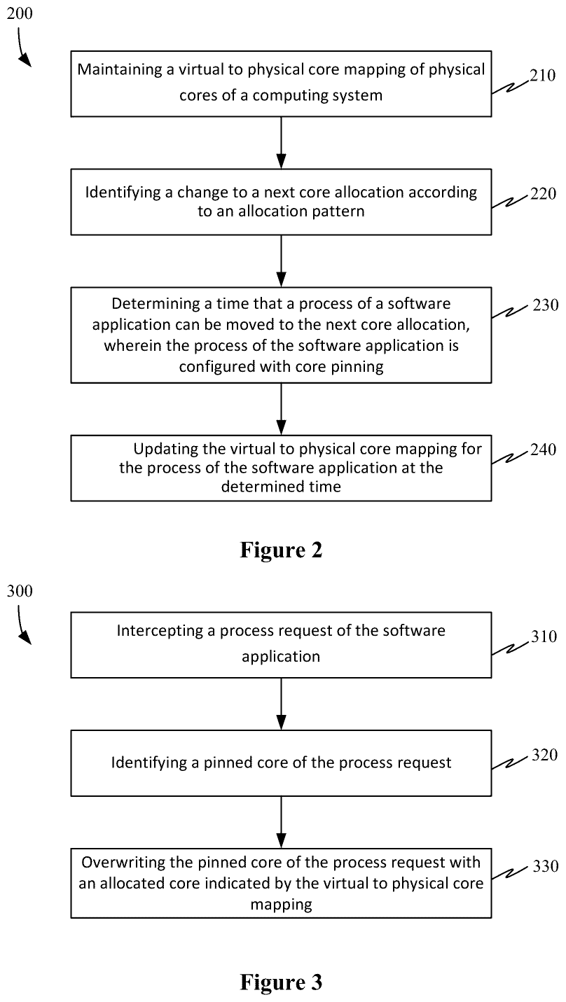

The allocator 130 can sit between the application and the operating system kernel, creating dynamic linkages between a virtual core (e.g., virtual core 0 142) and a physical core (e.g., physical core 0 102 or physical core 14 104). In various implementations, the allocator 130 can be implemented as part of the kernel layer or in different forms in different layers. For the virtual to physical core mapping, the allocator 130 can maintain a matrix or table of core utilization and in some cases can maintain information on processing load (e.g., workload) or other usage behavior with respect to process requests from a software application (and relationship to when such requests are occurring). The allocator 130 can assist with identifying which cores to use (e.g., allocation pattern) and when a switch can be made from one core to another core, for example performing method 200 as described with respect to FIG. 2.

FIG. 2 illustrates a method of core allocation for temperature control in under-subscribed computing systems. Referring to FIG. 2, method 200 includes maintaining (210) a virtual to physical core mapping of physical cores of a computing system: identifying (220) a change to a next core allocation according to an allocation pattern: determining (230) a time that a process of a software application can be moved to the next core allocation, wherein the process of the software application is configured with core pinning; and updating (240) the virtual to physical core mapping for the process of the software application at the determined time.

Since reallocation is possible even with pinned cores, method 200 supports application-agnostic core randomization.

Identifying (220) the change to the next core allocation according to the allocation pattern can include determining that a core's usage has satisfied a target length of time for a time period, determining that a core's usage has satisfied a target usage amount, or determining that temperature information satisfies a change condition, as some examples.

For identifying which cores to use when identifying (220) the change to the next core allocation (e.g., the allocation pattern), the allocator can implement any suitable algorithm for wear allocation. The algorithms for wear allocation can include assigning processes uniformly across all the cores and moving to a new core after a period of time or upon degradation to a certain extent. In addition, selection of which cores to move to can be based on any suitable allocation pattern, including, but not limited to, sequential and random.

Method 200 can include tracking core utilization of the physical cores of the computing system; and maintaining information of core utilization of the plurality of physical cores. This information can be used when identifying the change to the next core allocation according to the allocation pattern.

In various implementations, the trigger for changing cores can be based on timing (e.g., length of time), based on detected wear of the core, based on temperature conditions (e.g., that temperature information satisfies a change condition indicative of a pre-programmed temperature and/or period of time at a certain temperature that triggers a change), or some other method. For example, identifying the change to the next core allocation according to the allocation pattern can be triggered by temperature information, a target length of time for a time period, or a target usage amount indicated by the information of core utilization.

In some cases, there can be sensors or other hardware included on the chip to assist with operations of the allocator. For example, counters can be included that can assist with tracking numbers of various operations/behaviors. In some cases, the allocator can interface with power control functionality of an operating system, for example detection of an idle mode sleep behavior or low power mode.

For example, the computing system can further include temperature sensors coupled to the plurality of cores. The method can further include reading temperature from the temperatures sensors while tracking usage of the plurality of cores for maintaining the information of core utilization of the plurality of physical cores. As another example, the computing system can further include counters coupled to the plurality of cores, wherein the counters track counts of certain operations. The method can further include reading the counts of the certain operations while tracking usage of the plurality of cores for maintaining the information of core utilization of the plurality of physical cores.

In some cases, determining (230) the time that the process of the software application can be moved to the next core allocation can include determining one or more interruption time periods having a likelihood of a minimal number of process requests of the software application; and enabling a change from one core to a different core during an interruption time period of the one or more interruption time periods.

As used herein, “minimal” refers to a small or negligible amount, not necessarily the very least amount possible. Accordingly, the minimal number of process requests in a determined interruption time period can be the minimum number/least amount possible, but is allowed to include an amount more than the very least amount possible. In some cases, the minimal amount is user defined. For example, a minimal number of process requests can be defined as instructions retired per cycle as being below 2. As another illustrative example, a user can define a minimal number of process requests as the number of process requests satisfying a processor power draw below 0.1 watts.

In some cases, determining one or more interruption time periods having a likelihood of a minimal number of process requests of the software application can include determining behavior patterns, from historical process requests of the software application captured from the tracking of the process requests of the software application, wherein the behavior patterns include numbers of requests during different periods of time in a day, week, or month; and identifying, from the behavior patterns, the one or more interruption time periods having the minimal number of process requests. The predicted result can thus be based on a statistical analysis. In some cases, more complicated algorithms or approaches may be used.

In an illustrative scenario, the allocator can identify times that a core is idle using process request information; and based on the historical process request information, predict when the core will be idle, then move the context to another core. This idle prediction is used in place of a scheduler sending a ping to the processor, which interrupts workload operations. For some schedulers, the interruption could occur every few milliseconds to microseconds, which is not suitable for certain applications such as networking applications and other high throughput applications. In addition, for networking applications (e.g., for 5G networks), if the core was switched during a time that the workload was even moderate, cache data can be lost and misses can occur, resulting in a 5G network not meeting a service level agreement.

In some cases, the allocator can detect application traffic and at a time that there is no traffic or traffic below a certain threshold, a single core can be switched each day until each of the cores used by the software application have been moved. For example, if the software application indicates that three cores are pinned, the changing of cores can be carried out over three days.

In some cases, determining (230) the time that the process of the software application can be moved to the next core allocation can include determining that the time falls at a prescribed time of day, week, or month. In some cases, the timing for the switch can be input to the allocator by a user and the move of each core happens at the inputted prescribed time over the course of the number of days corresponding to the number of pinned cores.

In some cases, a combination of determined/predicted conducive times and prescribed times may be used.

In some cases, updating (240) the virtual to physical core mapping for the process of the software application at the determined time includes updating the virtual to physical core mapping of a particular physical core associated with a specified core affinity for a software application.

An allocator uses the virtual to physical core mapping updated according to method 200 when controlling pinned core affinity, for example as described with respect to method 300 of FIG. 3.

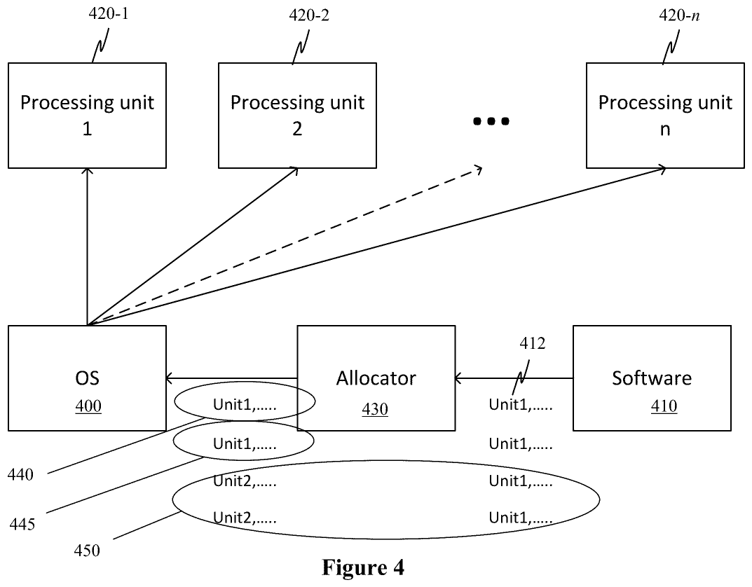

FIG. 3 illustrates a method of controlling pinned core affinity for core allocation for temperature control in under-subscribed computing systems. Referring to FIG. 3, method 300 includes intercepting (310) a process request of the software application; identifying (320) a pinned core of the process request; and overwriting (330) the pinned core of the process request with an allocated core indicated by the virtual to physical core mapping. An example is shown in the scenario illustrated in FIG. 4.

FIG. 4 illustrates operation of a computing system with a pinned processor affinitizer, providing core allocation for temperature control. Referring to FIG. 4, an operating system 400 loads a program or process from software 410 into a memory space accessible by a particular processing unit (e.g., first processing unit 420-1, second processing unit 420-2 . . . nth processing unit 420-n) and directs the particular processing unit to the memory address at which the program begins. In some cases, the software 410 requests specific processing units (e.g., through core pinning) and can send this information as part of the header (e.g., header 412) of the process.

An allocator 430 intercepts the process requests that are sent to the operating system 400 and performs operations to determine whether to change cores for wear purposes and also when to change cores. In the illustrated scenario, four process requests from software 410 are shown. As can be seen, software 410 indicates, for each process request, a specific processing unit of the first processing unit 420-1 (shown as “Unit1” in the Figure). The allocator 430 can determine that the core/processing unit being used for requests from software 410 is currently the first processing unit 420-1 and the processing requests 440 sent to the operating system 400 can indicate the first processing unit 420-1 (“Unit1”). It is possible that the allocator 430 determines that a change to cores/processing units should occur, but that the timing would not be appropriate. In such cases, the allocator 430 continues to allow processing requests (e.g., processing requests 445) for the operating system 400 with the previously indicated core/processing unit (e.g., the first processing unit 420-1). Then, at a time that the allocator 430 determines would be appropriate, the allocator 430 can change the header to a new core/processing unit (e.g., the second processing unit 420-2, with the reference shown as “Unit2” in the Figure), such as shown in process requests 450. When the core affinity is changed (e.g., as indicated by the header), the entire process changes to the new core(s).

In the illustrative scenario, the header is shown as a string (e.g., Unit 1, Unit 2); however, this is for illustrative purposes and is in operation based on the particular operating system 400 used for the computing system. For example, in Linux, the processor affinity property is represented as a bitmask, where each bit in the mask represents one of the cores. A 0 bit indicates that the process is excluded from running on the core corresponding to that location in the bitmask; and a 1 indicates that the process may run on that core. Accordingly, when the operating system is Linux, the allocator 430 can include scripts that modify the bitmask value for the processor affinity property to perform the overwriting of the specified core of the first process request with the different core (e.g., operation 330 of FIG. 3). In this manner, the described allocators (e.g., allocator 130, allocator 430) can be considered a pinned processor affinitizer that controls the processor affinity property for software indicating pinned processors.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as instructions, code, and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A method comprising:
maintaining a virtual to physical core mapping of physical cores of a computing system;
identifying a change to a next core allocation according to an allocation pattern;
determining a time that a process of a software application can be moved to the next core allocation, wherein the process of the software application is configured with core pinning; and
updating the virtual to physical core mapping for the process of the software application at the determined time.

2. The method of claim 1, further comprising:
intercepting a process request of the software application;
identifying a pinned core of the process request; and
overwriting the pinned core of the process request with an allocated core indicated by the virtual to physical core mapping.

3. The method of claim 1, wherein determining the time that the process of the software application can be moved to the next core allocation comprises:
determining one or more interruption time periods having a likelihood of a minimal number of process requests of the software application; and
enabling a change from one core to a different core during an interruption time period of the one or more interruption time periods.

4. The method of claim 3, wherein determining one or more interruption time periods having a likelihood of a minimal number of process requests of the software application comprises:
determining behavior patterns, from historical process requests of the software application, wherein the behavior patterns include numbers of requests during different periods of time in a day, week, or month; and
identifying, from the behavior patterns, the one or more interruption time periods having the likelihood of the minimal number of process requests.

5. The method of claim 1, wherein determining the time that the process of the software application can be moved to the next core allocation comprises:
determining that the time falls at a prescribed time of day, week, or month.

6. The method of claim 1, wherein updating the virtual to physical core mapping for the process of the software application at the determined time comprises:
updating the virtual to physical core mapping of a particular physical core associated with a specified core affinity for a software application.

7. The method of claim 1, wherein the allocation pattern is sequential.

8. The method of claim 1, wherein the allocation pattern is random.

9. The method of claim 1, wherein identifying the change to the next core allocation according to the allocation pattern comprises:
determining that a core's usage has satisfied a target length of time for a time period.

10. The method of claim 1, wherein identifying the change to the next core allocation according to the allocation pattern comprises:
determining that a core's usage has satisfied a target usage amount.

11. The method of claim 1, wherein identifying the change to the next core allocation according to the allocation pattern comprises:
determining that temperature information satisfies a change condition.

12. The method of claim 1, further comprising:
tracking core utilization of the physical cores of the computing system; and
maintaining information of core utilization of the physical cores,
wherein identifying the change to the next core allocation according to the allocation pattern is triggered by temperature information, a target length of time for a time period, or a target usage amount indicated by the information of core utilization.

13. A computer-readable storage medium having instructions for an allocator stored thereon that when executed by a processing unit, directs the processing unit to:
maintain a virtual to physical core mapping of physical cores of a computing system;
identify a change to a next core allocation according to an allocation pattern;
determine a time that a process of a software application can be moved to the next core allocation, wherein the process of the software application is configured with core pinning; and
update the virtual to physical core mapping for the process of the software application at the determined time.

14. The computer-readable storage medium of claim 13, wherein the instructions for the allocator further direct the processing unit to:
intercept a process request of the software application;
identify a pinned core of the process request; and
overwrite the pinned core of the process request with an allocated core indicated by the virtual to physical core mapping.

15. The computer-readable storage medium of claim 13, wherein the instructions to determine the time that the process of the software application can be moved to the next core allocation direct the processing unit to:
determine one or more interruption time periods having a likelihood of a minimal number of process requests of the software application; and
enable a change from one core to a different core during an interruption time period of the one or more interruption time periods.

16. The computer-readable storage medium of claim 13, wherein the instructions to determine the time that the process of the software application can be moved to the next core allocation direct the processing unit to:
determine that the time falls at a prescribed time of day, week, or month.

17. A computing system comprising:
a plurality of physical cores;
a system memory; and
an allocator stored on the system memory, wherein the allocator comprises instructions for performing a method comprising:
maintaining a virtual to physical core mapping and information of core utilization of the plurality of physical cores;
identifying a change to a next core allocation according to an allocation pattern;
determining a time that a process of a software application can be moved to the next core allocation, wherein the process of the software application is configured with core pinning;
updating the virtual to physical core mapping for the process of the software application at the determined time;
intercepting a process request of the software application;
identifying a pinned core of the process request; and
overwriting the pinned core of the process request with an allocated core indicated by the virtual to physical core mapping.

18. The computing system of claim 17, further comprising temperature sensors coupled to the plurality of physical cores, wherein the allocator further comprises instructions for reading temperature from the temperatures sensors while tracking usage of the plurality of physical cores for maintaining the information of core utilization of the plurality of physical cores.

19. The computing system of claim 17, further comprising counters coupled to the plurality of physical cores, wherein the counters track counts of certain operations, wherein the allocator further comprises instructions for reading the counts of the certain operations while tracking usage of the plurality of physical cores for maintaining the information of core utilization of the plurality of physical cores.

20. The computing system of claim 17, wherein the allocator interfaces with an operating system stored on the system memory.
